(19) United States
(12) Patent Application Publication
(10) Pub. No.: US 2016/0083937 A1
(43) Pub. Date: Mar. 24, 2016

(54) WATERING SYSTEM AND WATERING CONTROL METHOD

(71) Applicant: SOMFY SAS, Cluses (FR)

(72) Inventors: Pierre Emmanuel CAVAREC, Mont Saxonnex (FR); Sergyl CLERGET, Bluffy (FR); Fabien ROUSSEAU, Mieussy (FR)

(21) Appl. No.: 14/861,932

(22) Filed: Sep. 22, 2015

(30) Foreign Application Priority Data
Sep. 22, 2014 (FR) 14/58894

(51) Int. Cl. E03B 7/07; G05D 7/06

(52) U.S. Cl. CPC E03B 7/075; G05D 7/0635

(57) ABSTRACT

The invention concerns a watering system (1) comprising a controlled valve (2) arranged for monitoring the delivery of a watering liquid such as water or a nutrient solution through at least one watering conduit (11); at least one measurement sensor (3, 3a, 3b, 3c) arranged for providing measurement data of at least one physical quantity representative of the environment (DR); an electronic control unit (4) arranged for determining a watering control (Cmd) based on the measurement data of at least one physical quantity representative of the environment (DR) provided by the at least one measurement sensor (3), the controlled valve (2) being arranged for applying the watering control (Cmd) determined by the electronic control unit (4) so as to monitor the delivery of the watering liquid. The invention also concerns a watering control method.

### CROSS REFERENCE TO RELATED APPLICATION

This application is related to and claims the benefit of French Patent Application No. 14/58894 filed on 22 Sep. 2014, the contents of which are herein incorporated by reference in their entirety.

### TECHNICAL FIELD

The present invention concerns a watering system and a watering control and/or monitoring method.

### BACKGROUND

It is known to provide a watering system comprising at least one watering conduit intended to deliver a watering liquid such as water or a nutrient liquid, in particular in order to water one or several vegetable(s). Such a watering system may be associated to a programmable timer so as to proceed to watering in an automatic and selective manner for predefined time periods.

These arrangements give satisfaction in that they allow adapting the delivery of an amount of water based on a predefined program. Nonetheless, it appears that such a system does not allow taking into account the variability of the conditions of the environment, in particular when used for watering vegetables.

### BRIEF SUMMARY

The present invention aims to resolve all or part of the aforementioned drawbacks.

To this end, the present invention concerns a watering system comprising:

A controlled valve arranged for monitoring the delivery of a watering liquid such as water or a nutrient solution through at least one watering conduit;

At least one measurement sensor arranged for providing measurement data of at least one physical quantity representative of the environment;

An electronic control unit arranged for determining a watering control based on the measurement data of at least one physical quantity representative of the environment provided by the at least one measurement sensor,

the controlled valve being arranged for applying the watering control determined by the electronic control unit so as to monitor the delivery of the watering liquid.

According to one aspect of the invention, the controlled valve is arranged for delivering a watering flow-rate proportional to a value of the watering control provided by the electronic control unit.

These arrangements allow controlling the controlled valve based on the desired flow-rate, and not in an all-or-nothing fashion. Thus, it is possible to perform “drop-by-drop” or “high flow-rate” watering cycles while keeping control over the flow-rate and the total volume delivered.

Thanks to the arrangements according to the invention, the electronic control unit is arranged for determining a watering control adapted to the environmental conditions, on the basis of the measurement data communicated by the at least one sensor.

By watering control, it is meant, in particular, a definition of a value or a temporal evolution of a value which is desired for a control variable corresponding, for example, to a desired flow-rate in the at least one watering conduit or to an opening/closure section of the at least one watering conduit defined by the valve. It is also possible to define a watering control as an order or a set of opening/closure orders communicated to the controlled valve, and in particular to an actuator, in order to obtain a desired value of said control variable.

According to one aspect of the invention, the at least one sensor comprises a soil moisture sensor. In particular, the sensor is capable of determining the humidity by measuring the resistance at the terminals of a <<fork>> intended to be buried in the soil.

According to one aspect of the invention, the at least one sensor comprises a temperature sensor. In particular, the measured temperature is the temperature of the ambient air.

According to one aspect of the invention, the at least one sensor comprises an insolation sensor. This sensor may also be used for detecting the day/night alternations

For example, these arrangements allow the electronic unit to determine that watering is not desirable at midday in bright sunlight, and that watering may be triggered when the nightfall is detected or later on at night.

According to one aspect of the invention, in the case where the watering control is defined as an order or a set of opening/closure orders, a watering control message comprises at least a beginning action order and an end order of the watering. Thanks to these arrangements, it is possible to avoid the risk of not receiving an order for closing the valve.

According to one aspect of the invention, the determination of the watering control comprises a use of at least one control profile comprising several distinct phases.

In particular, a control profile may correspond to a model defining a temporal evolution of a desired value for a control variable, such as for example a flow-rate. In this respect, the distinct phases may correspond to distinct flow-rate levels.

In particular, the predefined control profile may correspond to a profile adapted to a specific type of vegetable to water, or still it may correspond to a temporal evolution profile of the watering control. According to one aspect of the invention, the system is arranged for adapting measurement intervals of the sensor. According to one aspect of the invention, the adaptation of the measurement intervals may be performed based on communication intervals with the electronic control unit or based on the variation or the relevance of the measurement values. For example, the measurement interval may be modified if variations with a determined magnitude have been detected. According to another example, the measurement interval may be reduced during a communication period with the electronic control unit.

These arrangements allow reducing the energy consumption of the system.

According to one aspect of the invention, the at least one control profile can be parameterized, in particular based on the collected data.

According to one aspect of the invention, the sensor and/or the solenoid valve comprise a photovoltaic module intended to produce the energy required for its operation and/or for charging a battery comprised in the sensor or in the solenoid valve. In the same manner, the electronic control unit may comprise a photovoltaic module.

These arrangements allow ensuring the supply of the sensor and/or the solenoid valve and/or the electronic control unit with energy.

According to one aspect of the invention, the sensor is arranged for differentiating between environment conditions corresponding to a luminosity level of a cloudy weather and a temporary decrease of luminosity corresponding, for example, to the passage of a cloud.

According to one aspect of the invention, the controlled valve comprises a valve with at least three passageways.

According to one aspect of the invention, the controlled valve comprises a first passageway intended to be connected to a first watering liquid supply source, a second passageway intended to be connected to a second watering liquid supply source and a third passageway being connected to the at least one watering conduit, the controlled valve being arranged so as to selectively connect the third passageway, which is connected to the at least one watering conduit, to the first passageway or to the second passageway.

In particular, these arrangements allow proceeding to watering while using a first watering liquid supply source constituted by a rainwater reservoir, and a second watering liquid supply source constituted by a connection to the drinking water distribution network. According to an aspect of the invention, it is possible in particular to consider using the rainwater reservoir in priority.

According to another aspect of the invention, a first passageway of the controlled valve is intended to be connected to a watering liquid supply source, a second passageway is intended to be connected to a first watering conduit and a third passageway is intended to be connected to a second watering conduit, the controlled valve being arranged so as to selectively connect the supply source to the first or to the second watering conduit.

These arrangements allow using the controlled valve to serve two watering areas from the same watering liquid supply.

According to one aspect of the invention, the watering system comprises at least one flow-rate sensor arranged for providing measurement data of a watering liquid flow-rate in the at least one watering conduit.

These arrangements allow the electronic unit to control the watering by defining a watering flow-rate to deliver to the vegetables. Moreover, the delivered volume may also be accurately determined. These arrangements allow achieving a more accurate watering than a watering cycle defined by a watering duration. The watering liquid flow-rate sensor may be integrated in the controlled valve or inserted in another portion of the system.

According to one aspect of the invention, the electronic unit is arranged for triggering a switching of the controlled valve based on a value representative of a low flow-rate, which value is communicated by the watering liquid flow-rate sensor, to another supply source, in the case where the controlled valve was a valve with at least there passageways.

As example, it is possible to preferably switch the controlled valve to a rainwater reservoir, and then, switch the valve to the drinking water supply network in the case where a quite low flow-rate is detected by the flow-rate sensor.

According to one aspect of the invention, the electronic control unit is arranged for periodically checking the filling condition of the water reservoir. In the case where a low flow-rate is detected (and therefore, a low level of the reservoir), it may be chosen to simply alert the user by means of an alert message, for example via a mobile terminal such as a smartphone.

According to one aspect of the invention, the flow-rate sensor is disposed downstream of the solenoid valve. According to another aspect of the invention, a flow-rate sensor is disposed upstream of the solenoid valve.

According to one aspect of the invention, the electronic control unit is arranged for comparing the measurement data of a watering liquid flow-rate, provided by the at least one flow-rate sensor, to the watering control, determined based on the measurement data of at least one physical quantity representative of the environment.

Thanks to these arrangements, the electronic control unit may perform a servo-control based on a desired flow-rate.

According to one aspect of the invention, the electronic control unit is arranged for performing an automatic diagnosis of the controlled valve. Thus, the electronic unit can determine the presence of a leakage if a significant flow-rate value is detected while the control of the controlled valve corresponds to a closed condition.

According to one aspect of the invention, the watering system comprises a turbine intended to supply the controlled valve with electric power.

These arrangements allow supplying the controlled valve with energy. In particular, it is possible to use a turbine or a micro-turbine for supplying a solenoid valve with power or for charging a battery of the solenoid valve.

According to one aspect of the invention, the turbine may be used both as a flow-rate sensor and as an electric power supply.

According to one aspect of the invention, the electronic control unit is disposed remote from the controlled valve and/or from the at least one measurement sensor, the electronic control unit as well as the controlled valve and/or the at least one measurement sensor comprising a remote communication interface, in particular a wireless communication interface.

According to one embodiment of the invention, the electronic unit may be integral with the at least one sensor, for example in a common enclosure.

According to another embodiment of the invention, the electronic unit may be integral with the controlled valve, for example in a common enclosure.

According to still another embodiment of the invention, the electronic unit is remote from both the at least one sensor and from the controlled valve.

According to one aspect of the invention, the communication interface of the electronic unit, of the at least one first measuring sensor and/or of the at least one second measuring sensor comprise radiofrequency-type communication interfaces.

According to one aspect of the invention, the system comprises a first electronic control unit and a second electronic control unit, the first electronic control unit and the second electronic control unit being arranged for communicating with each other so as to allow that one of the two electronic control units is identified as a master unit which defines the watering control.

In particular, these arrangements allow providing an electronic control unit in the sensor or in the controlled valve for carrying out the control method in the case where the system does not comprise a second electronic control unit constituted, for example, by a control entity of a home automation system, or when this second unit is not operating or when it is inaccessible by communication means. According to one aspect of the invention, the electronic control unit is arranged for collecting meteorological data and for determining the watering control also based on said meteorological data.

According to these arrangements, the electronic control unit may take into account the meteorological data, when determining the watering control, which meteorological data affect the water needs of the vegetables to water.

According to one embodiment, the electronic unit is arranged for collecting program data which are set or selected by a user and for determining the watering control also based on the program data.

According to one aspect of the invention, the watering system comprises a user interface system arranged for collecting program data which are set or selected by a user. In particular, the interface system may comprise a screen and control buttons, or a touchscreen, or an application hosted in a mobile terminal, or a web page accessible through a private or public network. The interface system is arranged for communicating with the electronic control unit.

According to one aspect of the invention, the user interface system comprises a button disposed on the sensor and/or on the solenoid valve.

In particular, this button is arranged for directly controlling the solenoid valve, or still for initiating a peering between the sensor and the solenoid valve or between the sensor and/or the solenoid valve and the electronic control unit.

According to another aspect of the invention, a specific remote-control may be provided for directly controlling the solenoid valve and/or the sensor.

On the basis of the measurement data of the different sensors, the meteorological data, and the program data of the user, the electronic unit can optimize a watering scenario. For example, the electronic may abort a watering cycle if a rainy day is forecasted for the next day by the meteorological data.

According to one aspect of the invention, the electronic unit may be arranged for accessing a reference database, concerning the types of vegetables to water and comprising data regarding the type of watering to apply to said vegetables, so as to determine a watering option.

According to one aspect of the invention, the system comprises a memory intended to store a reference database concerning the types of vegetables to water.

According to one embodiment, the controlled valve comprises an electrically-controlled valve or solenoid valve. According to a first possibility, said solenoid valve may be supplied with power by a cell, by a battery or still by a photovoltaic module.

According to a second possibility, the controlled valve may be supplied with power by a turbine, in particular a micro-turbine arranged for providing the energy that is required for the operation of the controlled valve, the turbine being driven by the watering liquid flow through the controlled valve.

According to one aspect of the invention, the controlled valve may be arranged so as to be closed by default in the absence of supply or in the event of a failure or when no control is communicated by the electronic unit.

According to several possibilities, the used controlled valve may comprise, in particular, of a pilot-operated solenoid valve, which valve comprises a return spring with a top dead center when in the open position, and which valve uses the flow in order to reduce the energy required for its closure. The selection of the controlled valve type is guided by the desired energy consumption in the open position and the energy required for its closure.

The present invention also concerns a method for controlling a watering system comprising:

collecting measurement data of at least one physical quantity representative of the environment;

determining a watering control based on the measurement data of at least one physical quantity representative of the environment;

A watering step during which the delivery of a watering liquid, such as water or a nutrient solution, is carried out in compliance with the watering control.

According to one aspect of the invention, the watering control determination step comprises the use of at least one watering control profile, said watering control profile comprising at least one first watering phase at a first flow-rate value for a first watering period, and then, a second watering phase at a second flow-rate value for a second watering period, the second flow-rate value being higher than the first flow-rate value.

Hence, the distinct phases correspond to watering cycles according to different flow-rates or according to different flow-rate variations.

These arrangements allow preparing/moistening the soil during the first phase with a low flow-rate in order to avoid any runoff during the second phase, and then proceeding to watering with a second higher flow-rate during the second phase.

As example, the end of the second phase may be determined when a satisfactory level of humidity is observed by a moisture probe.

According to one aspect of the invention, during the watering step, the watering liquid is delivered at a watering flow-rate proportional to a value of said watering control.

This arrangement allows adapting the watering flow-rate based on the desired flow-rate, and not watering in an all-or-nothing fashion. Thus, it is possible to perform “drop-by-drop” or “high flow-rate” watering cycles while keeping control over the flow-rate and the total volume delivered.

According to one aspect of the invention, the at least one control profile can be parameterized, in particular based on the collected data.

In particular, the at least one predefined control profile or scenario may correspond to a profile adapted to a specific type of vegetable to water, or still to a temporal evolution profile of the watering control. According to one aspect of the invention, the control profile Pr may be defined by determining the watering liquid flow-rate as a function of the variation of the humidity observed by the probe over a time period. The time period may be defined prior to a watering period, and/or during a watering period, or still next to a watering period.

According to one aspect of the invention, the defined control profile triggers the watering cycle preferably during the early hours of the morning, in particular the three or two first hours, after the sunrise and/or during the last hours of the day, in particular the three or two last hours preceding the sunset.

These arrangements allow avoiding watering at night because the plants absorb less water and it avoids watering when the plants are highly exposed to the sun.

According to one aspect of the invention, the predefined profile may be parameterizable.

According to one aspect of the invention, the control method further comprises collecting measurement data of a watering liquid flow-rate obtained through a measurement in at least one watering conduit, the watering control determination step comprising a determination of a watering control further carried out based on the flow-rate measurement data.

According to one aspect of the invention, the method comprises comparing the obtained measurement data of a watering liquid flow-rate to a measurement of the watering control.

According to one aspect of the invention, the control method further comprises selecting a watering liquid supply source among a plurality of watering liquid supply sources, the amount of watering liquid that is delivered during the watering step being drained from the selected supply source.

According to one aspect of the invention, the control method further comprises collecting meteorological data, the watering control determination step comprising a determination of a watering control further carried out based on the meteorological data.

According to one aspect of the invention, the control method further comprises collecting program data which are set or selected by a user, the watering control determination step comprising a determination of a watering control also based on the program data.

In particular, the program data may correspond to a selected operation program of the system, or still they may correspond to usage data or direct control data of the system which data are provided by a user. The selection of a program of operation may correspond to the selection of a pre-established control profile or scenario. The control may be performed on the basis of a time and/or a flow-rate and/or a volume criterion. The control profile may correspond to the definition of constraints on the watering flow-rate or on the watering volume.

According to one aspect of the invention, the control method may comprise checking at least one safety criterion regarding the watering volume or the watering duration while providing for a stop threshold beyond a maximum watering duration or a maximum watering volume.

According to one aspect of the invention, the control method comprises a learning step during which a correlation is established between the program data and the measurement data of at least one physical quantity representative of the environment so as to determine learning data,

the watering control determination step comprising a determination of a watering control further carried out based on the learning data.

These arrangements allow proceeding to a learning step during a use period, in particular during a first-time use period, for example a few days, during which correlations are established between the program data that reflect the habits of the user/customer and the measurement data of at least one physical quantity representative of the environment, such as in particular the humidity of the soil, the temperature or the insolation.

The present invention also concerns, a method for controlling a watering system comprising:

collecting measurement data of at least one physical quantity representative of the environment;

determining a watering control based on the measurement data of at least one physical quantity representative of the environment;

A watering step during which the delivery of a watering liquid, such as water or a nutrient solution, is carried out in compliance with the watering control, the watering liquid being delivered at a watering flow-rate proportional to a value of said watering control.

This arrangement allows adapting the watering flow-rate based on the desired flow-rate, and not watering in an all-or-nothing fashion. Thus, it is possible to perform “drop-by-drop” or “high flow-rate” watering cycles while keeping control over the flow-rate and the total volume delivered.

### BRIEF DESCRIPTION OF THE DRAWINGS

Anyway, the invention will be better understood upon reading the description that follows with reference to the appended schematic drawings representing, as a non-limiting example, an embodiment of this system and of this watering method.

FIG. 1 is a schematic view of a watering system.

FIG. 2 is a flowchart of the steps of a watering method.

FIG. 3 is a front view of a two-way solenoid valve according to a first embodiment.

FIG. 4 is a perspective view of the solenoid valve of FIG. 3.

FIG. 5 is a front view of a three-way solenoid valve according to a second embodiment.

FIG. 6 is a perspective view of the solenoid valve of FIG. 5.

FIG. 7 is a front view of a sensor.

FIG. 8 is a perspective view of the sensor of FIG. 7.

FIG. 9 is a scheme representative of a control profile.

### DETAILED DESCRIPTION

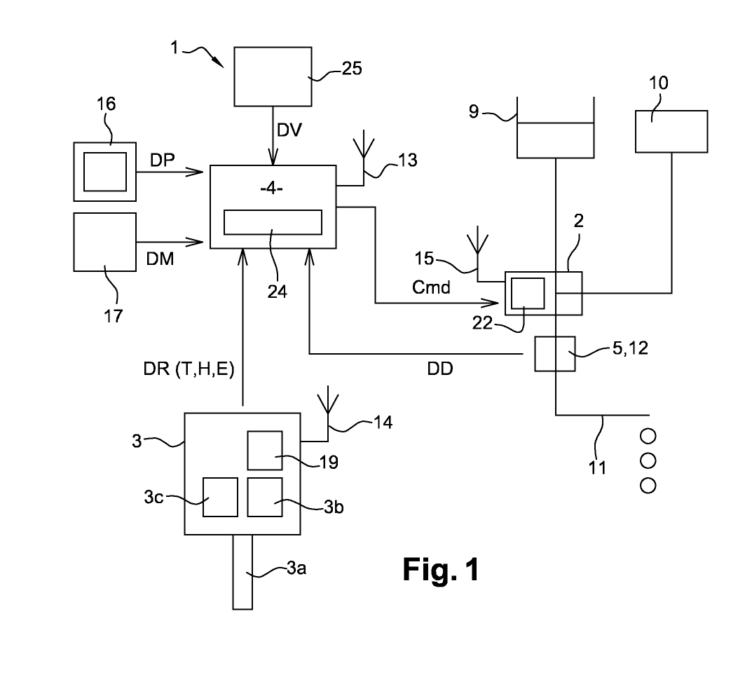

As illustrated in FIG. 1, the watering system 1 comprises a controlled valve 2 arranged for monitoring the delivery of a watering liquid, such as water or a nutrient solution, through at least one watering conduit 11, a measurement sensor 3 arranged for providing measurement data of at least one physical quantity representative of the environment DR and an electronic control unit 4.

The sensor 3 is represented in FIG. 1 and in FIGS. 7 and 8. This sensor comprises a soil moisture sensor 3a. In particular, the moisture sensor 3a is capable of determining the humidity by measuring the resistance at the terminals of a fork 17 comprising two branches intended to be buried in the soil.

The sensor 3 may also comprise a temperature sensor 3b, in particular a sensor for measuring the temperature of the ambient air and/or an insolation sensor 3c. In particular, the insolation sensor 3c is arranged for differentiating between a daytime situation and a nighttime situation, or for differentiating between environment conditions corresponding to a luminosity level of a cloudy weather and a temporary decrease of luminosity corresponding, for example, to the passage of a cloud.

Moreover, the sensor 3 comprises a photovoltaic module 18 intended to produce the energy required for its operation and/or for charging a battery comprised in the sensor or in the solenoid valve. Alternatively, it may be powered by cells.

Moreover, the sensor 3 comprises an electronic processing unit 19 and a remote communication interface 14 intended for communication with the central entity 4.

According to the embodiment presented in FIGS. 7 and 8, the sensor 3 presents an elongated shape between a first profiled end on which the fork 17 is positioned and which is intended to be driven into the soil, and a second enlarged end comprising the photovoltaic module and which is intended to be positioned opposite to the soil. The temperature 3b and insolation 3c sensors are disposed at the second enlarged end.

The electronic processing unit 19 of the sensor may be arranged for adapting the measurement intervals of the sensor. In particular, the adaptation of the measurement intervals may be performed based on the communication interval with the electronic control unit 4 or based on the variation or the relevance of the measurement values. For example, the measurement interval may be modified if variations with a determined magnitude have been detected during a communication period with the electronic control unit.

Two embodiments of a controlled valve, in particular solenoid valves, will be described hereinafter with reference to FIGS. 3 to 6.

In all embodiments, the controlled valve 2, 2′ is arranged for applying a watering control Cmd determined by the electronic control unit 4 so as to monitor the delivery of a watering liquid, such as water or a nutrient solution.

The controlled valve 2, 2′ is equipped with a flow-rate sensor 5, integrated to the valve and arranged for providing measurement data of a watering liquid flow-rate DD in the watering conduit 11, which sensor may be positioned upstream or downstream of the solenoid valve. Positioning the sensor downstream of the valve allows for a simple determination of the flow-rate through the controlled valve 2, 2′.

The valve 2, 2′ may comprise a turbine or a micro-turbine 12, in particular integrated in the flow-rate sensor 5, intended to supply the controlled valve 2, 2′ with electric power, for supplying a solenoid valve or for recharging a battery of the solenoid valve.

In particular, the controlled valve 2, 2′ may comprise a valve arranged for delivering a watering flow-rate proportional to a value of the watering control Cmd provided by the electronic control unit 4.

The controlled valve 2, 2′ may comprise a photovoltaic module 20, 20′ intended to produce the power required for its operation and/or for charging a battery comprised in the valve.

According to one variant which is not represented and which comprises no photovoltaic modules, the valve may be powered by a cell, by a battery or still by a photovoltaic module.

Moreover, the controlled valve 2, 2′ comprises an electronic processing unit 22 and a remote communication interface 15 intended for communication with the central entity 4.

The valve further comprises a button 23, 23′, in particular arranged for directly controlling the solenoid valve. In particular, the direct control button may function according to a sequential opening/closure cycle. For safety reasons, a direct opening control cannot be maintained indefinitely and a programmed switch-back into the closed condition will be implemented without requiring any other manipulation of the direct control button. According to one variant, this button may be arranged for initiating a peering between the sensor and the solenoid valve or between the sensor and/or the solenoid valve and the electronic control unit.

According to the embodiment of the system presented in FIG. 1, the controlled valve 2 comprises a valve with at least three passageways. A valve of this type is represented in FIGS. 3 and 4. The controlled valve 2 comprises a first passageway 6 intended to be connected to a first watering liquid supply source 9, for example constituted by a rainwater reservoir, and a second passageway 7 intended to be connected to a second watering liquid supply source 10, for example a drinking water distribution network, and a third passageway 8 being connected to a watering conduit 11. The controlled valve is arranged so as to selectively connect the third passageway 8, connected to the at least one watering conduit 11, to the first passageway 6 or to the second passageway 7 so as to implement the control Cmd communicated by the electronic control unit 4. The three-way valve prevents any direct connection between the two inlets so as to avoid that rainwater is reinjected in the drinking water network: either by means provided in the enclosure of the solenoid valve, or by external means. In particular, the solenoid valve may comprise abutments intended to restrict the connection between the first inlet and the outlet or between the second inlet and the outlet and/or check valves.

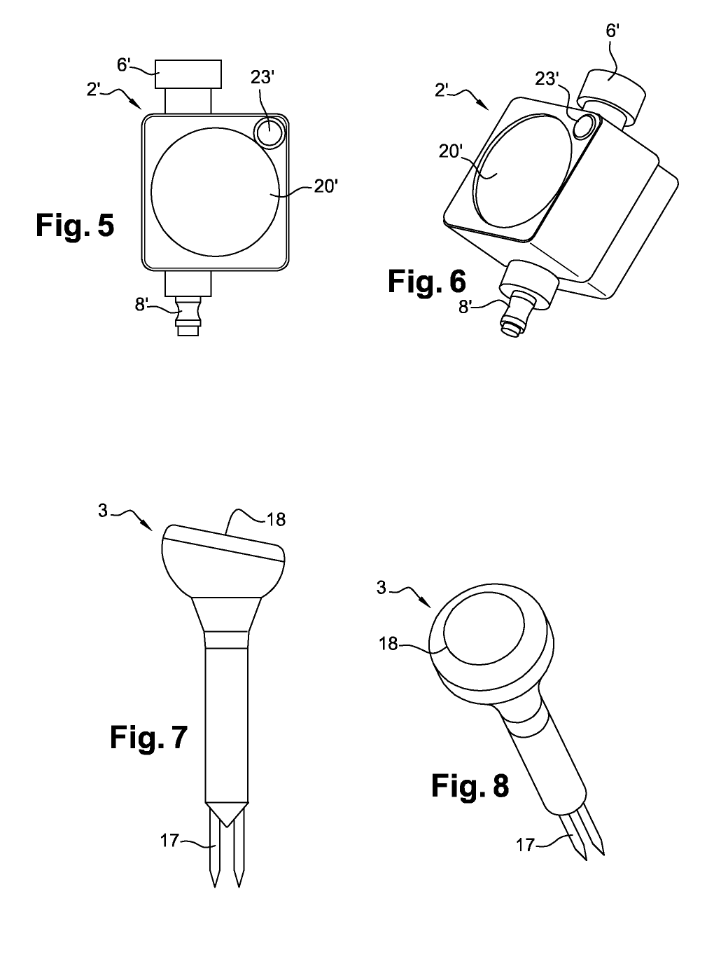

According to a second embodiment represented in FIGS. 5 and 6, a controlled valve comprises one single inlet 6′ and an outlet 8′. The valve controls the passageway from the single inlet to the outlet from one single watering liquid supply.

According to one variant which is not represented, which uses a three-way valve, a first passageway of the controlled valve may be connected to a watering liquid supply source, a second passageway is intended to be connected to a first watering conduit, and a third passageway is intended to be connected to a second watering conduit, the controlled valve being arranged so as to selectively connect the supply source to the first or to the second watering conduit.

According to one variant which is not represented, the watering liquid flow-rate sensor may be inserted in another portion of the system.

The controlled valves may be arranged so as to be closed by default in the absence of supply or in the event of a failure or when no control is communicated by the electronic unit. Alternatively or complementarily, in the case where the watering control is defined as an order or a set of opening/closure orders, it is possible to consider a watering control frame or message comprising at least one order for starting watering at the beginning and at least one order for stopping watering at the end.

According to several possibilities, the controlled valves that are used may comprise, in particular, of controlled solenoid valves, the valve being in such an unstable position that the energy that is required for closing it is lower than the energy that is required for opening it. For example, the valve may comprise a spring for returning it to a closed position and/or use the flow so as to reduce the energy that is required for closing it.

In particular, a controlled valve comprises at least one actuator comprising a motor and a speed reduction device, the output of which drives one or several opening/closure flap(s), or nuts, these being capable of being set in positions where they free or obstruct, at least partially, the passage of the liquid in the passageway(s) of the controlled valve.

The electronic control unit 4 is arranged for determining and/or for implementing one or several watering control(s) Cmd.

According to the embodiment represented in FIG. 1, the electronic control unit 4 is disposed remote from the controlled valve 2 and from the measurement sensor 3.

According to this configuration, wherein the electronic unit is remote from both the at least one sensor and from the controlled valve, the electronic control unit 4 may be formed by a central control entity of a home automation system. The central control entity may comprise a communication gateway to a communication network external to the system, for example Internet. As example, a gateway such as a home box (for example, a Tahoma® box) may be used. The central control entity may also comprise a user interface system 16 connected to a data entry and display terminal, communicating with the gateway.

The electronic control unit 4 comprises an electronic processing unit 24 as well as a remote communication interface 13, in particular a wireless communication interface, which allows communicating with the electronic processing unit 19, 22 as well as the remote communication interface 14, 15 of the controlled valve 2 and of the measurement sensor 3. In particular, the communication between the electronic processing unit 4, the controlled valve 2 and the sensor 3 may comprise a radiofrequency-type communication.

The electronic control unit 4 is arranged for collecting all or part of a set of input data.

Thus, the electronic control unit 24 is arranged for collecting measurement data of at least one physical quantity representative of the environment DR provided by the measurement sensor 3, in particular data regarding moisture H, and/or insolation E, and/or temperature T.

The electronic processing unit may also be arranged for collecting measurement data of a watering liquid flow-rate DD provided by the at least flow-rate sensor 5.

The electronic processing unit may also be arranged for collecting program data DP which are set or selected by a user.

In particular, the program data may correspond to the selection of a program of operation of the system, or still they may correspond to usage data or direct control data of the system which data are provided by a user. The selection of a program of operation may correspond to the selection of a pre-established control profile or scenario.

To this end, the user interface system 16 is arranged for collecting program data DP which are to be set and/or selected by a user. In particular, the interface system may comprise a screen and control buttons, or a touchscreen, or an application hosted in a mobile terminal, or a web page accessible through a private or public network. The interface system is arranged for communicating with the electronic control unit. This interface system may be hosted on a central entity of a home automation system forming the electronic control unit.

The interface system may also be interactive or comprise the control button 23, 23′ disposed on the controlled valve.

According to one variant which is not represented, the user interface system may also comprise a specific remote-control provided for directly controlling the solenoid valve and/or the sensor.

The electronic control unit may be arranged for collecting meteorological data DM. In particular, this collection may be carried out by remotely-accessing, through a network, a meteorological data distribution service.

Furthermore, the electronic control unit may be arranged for accessing a reference database 25, concerning the types of vegetables to water and comprising data regarding the type of watering to apply to said vegetables, in order to collect reference data concerning the vegetables DV. This reference database 25 may be remotely-accessible through a network. Alternatively, the system, and in particular the electronic control unit, may comprise a memory intended to store such a reference database.

The reference database 25 may also comprise data concerning types of soils or ground to water and comprising data regarding the type of watering to apply, in preference, to said soils, for example based on their composition and their profile.

The processing unit may be arranged so as to present a learning operation mode which allows collecting learning data DA concerning the use of the system.

The processing unit 24 is arranged for determining the watering control Cmd based on all or part of the following data which correspond to parameters of the watering control:

measurement data of at least one physical quantity representative of the environment DR, provided by the measurement sensor 3.

measurement data of a watering liquid flow-rate DD.

program data DP.

meteorological data DM.

reference data concerning the vegetables DV.

learning data DA.

On the basis of the measurement data of the different sensors, the meteorological data, the program data of the user and/or the learning data, the electronic unit can determine a watering control Cmd, by using, for example, at least one predefined control profile Pr which may be parameterized based on the collected data. This determination step will be described later on.

The electronic control unit 4 may be arranged for comparing the measurement data of a watering liquid flow-rate DD, provided by the at least one flow-rate sensor 5, to the watering control Cmd, in particular in order to implement a servo-control and a regulation of the watering control Cmd.

According to one variant which is not represented, the electronic unit may be integral with the at least one sensor, for example in a common enclosure.

According to another variant which is not represented, the electronic unit may be integral with the controlled valve, for example in a common enclosure.

According to another variant which is not represented, the system comprises a first electronic control unit and a second electronic control unit, the first electronic control unit and the second electronic control unit being arranged for communicating with each other so as to allow that one of the two electronic control units is identified as a master unit which defines the watering control.

When implementing the watering control by the controlled valve 2, 2′, the electronic processing unit 15 of the valve monitors the operation of the motor, and consequently, the degree of opening of the flap(s) which obstruct the passageways of the valve. By monitoring the angular position at the output of the motor, the section through which the watering liquid circulates is thus monitored, and therefore, the watering flow-rate (for a given pressure) is controlled. This flow-rate may be checked by reading the measurement provided by the watering liquid flow-rate sensor.

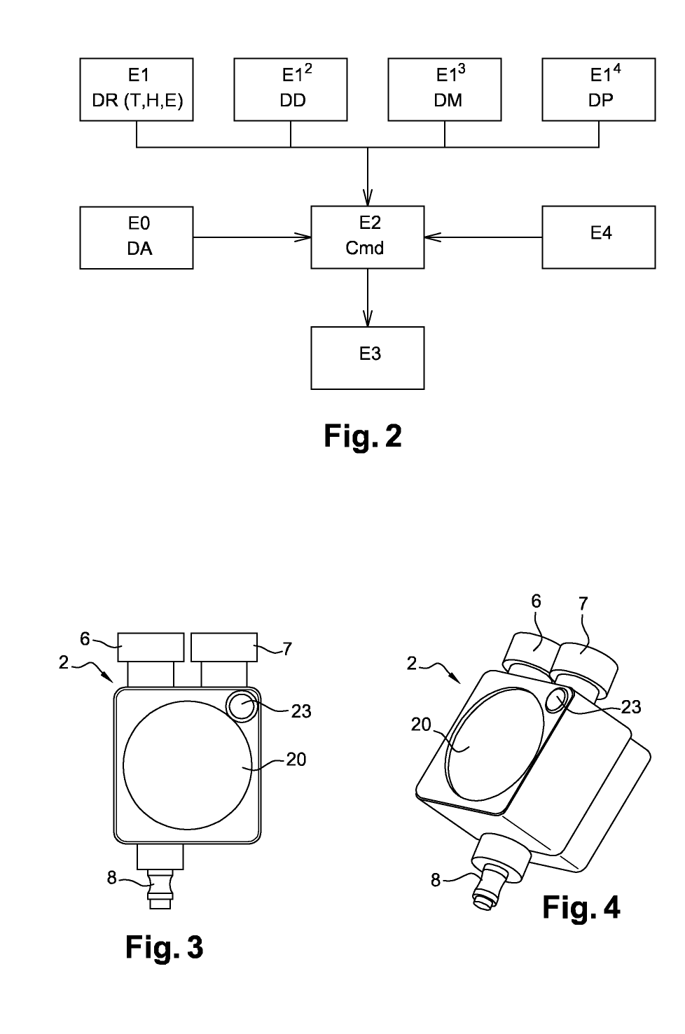

The watering system 1 control method will be described hereinafter with reference to FIG. 2.

The control method may comprise an initial learning step E0 during which a correlation is established between the program data DP and the measurement data of at least one physical quantity representative of the environment DR so as to determine the learning data DA.

For example, it is possible to carry out a learning step during a use period, in particular during a first-time use period, for example a few days, during which correlations are established between the program data which reflect the habits of the user/customer and the measurement data of at least one physical quantity representative of the environment, such as in particular the humidity of the soil, the temperature or the insolation. In particular, the rate of absorption of the watering liquid by the soil may be learnt (thanks to a correlation between the watering or rain data, and the data provided by the soil moisture sensor). The knowledge of the absorption rate may be used for defining a maximum watering flow-rate.

The learning data DA may be used later on to determine a watering control Cmd.

Subsequently to the initial learning step E0, if the latter is carried out, one or several data collection step(s), which have been described above, may be carried out, and in particular:

E1: collecting measurement data of at least one physical quantity representative of the environment DR,

E1²: collecting measurement data of a watering liquid flow-rate DD, obtained through a measurement in the watering conduit 19,

E1³: collecting meteorological data DM,

E14: collecting program data DP, which are set or selected by a user.

It should be noted that reference data concerning the vegetables DV may also be collected as has been seen before.

On the basis of the collected data, a step E2 consisting in determining a watering control Cmd is carried out.

The determination of the watering control E2 may comprise the use of at least one predefined control profile or scenario Pr, in particular parameterizable, which considers one or several distinct phase(s). In particular, the control profile Pr may correspond to a profile adapted to a specific type of vegetable to water, or still to a temporal evolution profile of the watering control. These arrangements allow optimizing a watering scenario so as to reduce water consumption while improving the moisture content of the soil in the long-term.

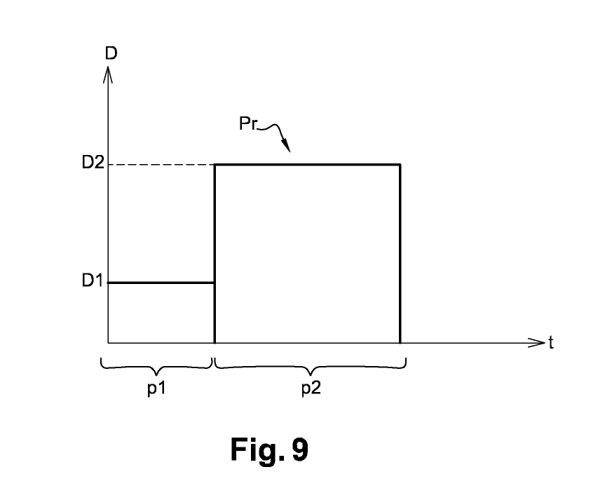

According to a first example represented in FIG. 9, a control profile Pr comprises at least one first watering phase at a first flow-rate value D1 for a first watering period p1, and then, a second watering phase at a second flow-rate value D2, higher than D1, for a second watering period p2. Thus, it is possible to prepare/humidify the soil during the first phase with a low flow-rate in order to avoid any runoff of the watering liquid, and then, proceed to watering at a higher second flow-rate during the second phase. The end of the second phase may be determined when a satisfactory level of humidity is observed on the basis of data provided by the moisture sensor 3a or by the end of the scheduled watering period.

According to another example, the control profile Pr may be defined by determining the watering liquid flow-rate as a function of the variation of the humidity observed by the probe over a time period. The time period may be defined prior to a watering period, and/or during a watering period, or still next to a watering period.

According to another example, the control profile Pr over a few days may be defined according to “moisty soil—dry soil” cycles, these cycles being possibly necessary to the proper development of the roots of some vegetables.

According to another example, the control profile Pr may integrate watering rationing. This rationing may be based on information concerning a drought period, which is provided to the electronic control unit or defined from the information regarding the decrease of the water level in a rainwater recovery tank. In particular, the water level in the rainwater recovery tank may be assayed from a flow-rate variation measured by the flow-rate sensor of the controlled valve.

According to another example, the control profile Pr may allow managing two (and even three) different areas by projecting water from a sprinkler connected to the end of the watering conduit. In this case, the control profile integrates variations in the water flow-rate: with a low flow-rate, it is possible to water in the proximity of the sprinkler, whereas with a high flow-rate, watering is performed several meters away in a second region. The control profile may be defined so as to trigger the watering cycle preferably during the early hours of the morning, in particular the three or two first hours, after the sunrise and/or during the last hours of the day, in particular the three or two last hours preceding the sunset.

Detection of the day/night alternation may be achieved, in particular, by means of the insolation sensor. The electronic control unit may also comprise a clock intended to enable hourly programming which may also achieve this detection.

The control profile or scenario may correspond to the definition of a constraint on the watering flow-rate or on the watering volume which constraint varies over time. The control may be performed on the basis of a time and/or a flow-rate and/or a volume criterion.

The control method may comprise checking at least one safety criterion regarding the watering volume or the watering duration while providing for a stop threshold beyond a maximum watering duration or a maximum watering volume.

Finally, a watering step E3 is carried out during which a watering liquid is delivered in compliance with the watering control Cmd.

The control method may also comprise comparing the measurement data of a watering liquid flow-rate obtained by a measurement of the watering control, in particular for checking the compliance between the flow-rate of the delivered watering liquid and the expected watering control.

This comparison allows performing a servo-control based on a desired flow-rate through a control loop which allows obtaining a more accurate control of the watering cycle. This comparison also, or alternatively, allows performing an automatic diagnosis of the controlled valve. Thus, the electronic unit can determine the presence of a leakage if a significant flow-rate value is detected while the control of the controlled valve corresponds to a closed condition.

The method may also comprise selecting a watering liquid supply source among a plurality of watering liquid supply sources 9, 10, the amount of watering liquid that is delivered during the watering step E3 being drained from the selected supply source.

Thus, it is possible to trigger the switching of the controlled valve based on a value representative of a low flow-rate, which value is communicated by the watering liquid flow-rate sensor 5, to another supply source, in the case where the controlled valve is a three-way valve. Thus, as example, in the embodiment of a system as described in FIG. 1, it is possible to preferably switch the controlled valve to a rainwater reservoir, and then, switch the valve to the drinking water supply network in the case where a quite low flow-rate is detected by the flow-rate sensor 5. It is also possible to periodically check the filling condition of the water reservoir 9.

It goes without saying that the invention is not limited to the sole embodiment of this device and of this control and/or monitor system, described above as example, but in encompasses, on the contrary, all variants thereof.

In the present application, the tem watering encompasses the watering of soils and vegetables, but also the management of the water delivery in the context of home automation applications, inside or outside a building, in particular for the management of the supply of one or several water jet(s), the filling of one or several water basin(s), the management of one or several mist humidifier(s), in particular for terraces.

1. A watering system comprising:
a controlled valve arranged for monitoring delivery of a watering liquid through at least one watering conduit;
at least one measurement sensor arranged for providing measurement data of at least one physical quantity representative of an environment; and
an electronic control unit arranged for determining a watering control based on measurement data of at least one physical quantity representative of the environment provided by the at least one measurement sensor,
wherein the controlled valve being arranged for applying watering control determined by the electronic control unit so as to monitor delivery of the watering liquid, and
wherein the controlled valve being arranged for delivering a watering flow-rate proportional to a value of the watering control provided by the electronic control unit.

2. The watering system according to claim 1, wherein the determination of the watering control comprises use of at least one control profile (Pr) comprising several distinct phases.

3. The watering system according to claims 1, wherein the controlled valve comprises a valve with at least three passageways.

4. The watering system according to claim 3, wherein the controlled valve comprises a first passageway intended to be connected to a first watering liquid supply source, a second passageway intended to be connected to a second watering liquid supply source and a third passageway being connected to the at least one watering conduit, the controlled valve being arranged so as to selectively connect the third passageway, which is connected to the at least one watering conduit, to the first passageway or to the second passageway.

5. The watering system according to claim 1, comprising at least one flow-rate sensor arranged for providing measurement data of a watering liquid flow-rate in the at least one watering conduit.

6. The watering system according to claim 5, wherein the electronic control unit is arranged for comparing the measurement data of a watering liquid flow-rate, provided by the at least one flow-rate sensor, to the watering control, determined based on the measurement data of at least one physical quantity representative of the environment.

7. The watering system according to claim 1, wherein the electronic control unit is disposed remote from the controlled valve and/or from the at least one measurement sensor, the electronic control unit as well as the controlled valve and/or the at least one measurement sensor comprising a remote communication interface.

8. A method for controlling a watering system comprising:
collecting measurement data of at least one physical quantity representative of the environment;
determining a watering control based on the measurement data of at least one physical quantity representative of the environment, the watering control determination step comprising use of at least one watering control profile, said watering control profile comprising at least one first watering phase at a first flow-rate value for a first watering period, and then, a second watering phase at a second flow-rate value for a second watering period, the second flow-rate value being higher than the first flow-rate value; and
a watering step during which delivery of a watering liquid, is carried out in compliance with the watering control.

9. The method for controlling a watering system according to claim 8, further comprising:
collecting measurement data of a watering liquid flow-rate obtained through a measurement in at least one watering conduit,
the watering control determination step comprising a determination of a watering control further carried out based on the flow-rate measurement data.

10. The method for controlling a watering system according to claim 8, further comprising:
selecting a watering liquid supply source among a plurality of watering liquid supply sources;
the amount of watering liquid that is delivered during the watering step being drained from the selected supply source.

11. The method for controlling a watering system according to claim 8, further comprising:
collecting meteorological data,
the watering control determination step comprising a determination of a watering control further carried out based on the meteorological data.

12. The method for controlling a watering system according to claim 8, further comprising:
collecting program data which are set or selected by a user,
the watering control determination step comprising a determination of a watering control further carried out based on the program data.

13. The method for controlling a watering system according to claim 12, comprising a learning step during which a correlation is established between the program data and the measurement data of at least one physical quantity representative of the environment so as to determine learning data,
the watering control determination step comprising a determination of a watering control further carried out based on the learning data.

14. A method for controlling a watering system comprising:
collecting measurement data of at least one physical quantity representative of the environment;
determining a watering control based on the measurement data of at least one physical quantity representative of the environment; and
a watering step during which the delivery of a watering liquid, is carried out in compliance with the watering control, the watering liquid being delivered at a watering flow-rate proportional to a value of said watering control.
